(19) United States
(12) Patent Application Publication
(10) Pub. No.: US 2015/0129723 A1
(43) Pub. Date: May 14, 2015

(54) WIRE HOLDER

(71) Applicant: Yazaki Corporation, Tokyo (JP)

(72) Inventors: Kiyotaka HANAOKA, Kakegawa-shi (JP); Takanori KANAMORI, Kakegawa-shi (JP); Takuomi WADA, Kakegawa-shi (JP)

(73) Assignee: YAZAKI CORPORATION, Tokyo (JP)

(21) Appl. No.: 14/537,126

(22) Filed: Nov. 10, 2014

(30) Foreign Application Priority Data
Nov. 11, 2013 (JP) 2013-233440

(51) Int. Cl. B60R 16/02

(52) U.S. Cl. CPC B60R 16/0215
USPC 248/51

(57) ABSTRACT

A wire holder includes: a holder body attachable to a tubular body; wire passing holes formed in the holder body; and second locking parts provided on a periphery of the holder body and engageable with respective first locking parts of the tubular body. The holder body is divided along an axial direction of the wire passing holes into holder elements containing at least adjacent first and second holder elements, and is formed by superposing the holder elements. Each holder element includes at least one of the wire passing holes and at least one of the second locking parts. A first dividing surface of the first holder element is provided with a rib extending in the axial direction. A second dividing surface of the second holder element opposing the first dividing surface is provided with a groove with which the rib is engaged by sliding.

### CROSS REFERENCE TO RELATED APPLICATION(S)

This application is based on and claims priority from Japanese Patent Application (Application No. 2013-233440) filed on Nov. 11, 2013, the entire contents of which are incorporated herein by reference.

### BACKGROUND

1. Field of the Invention

One or more embodiments of the present invention relate to a wire holder through which electric wires are passed.

2. Description of the Related Art

A plurality of electric appliances are mounted on a vehicle, and a wire harness is arranged in the vehicle, for the purpose of transmitting electric power, control signals, etc., to these electric appliances. This wire harness is provided with a plurality of electric wires and connectors. In case where the wire harness is connected to the electric appliances of this type, a housing in a tubular shape is formed so as to project from a wall of a case which contains the electric appliances, and by attaching a wire holder in a tubular shape through which a plurality of the electric wires of the wire harness are passed to the housing, the electric wires which are guided out from the wire holder are introduced into the case through the housing, thereby to electrically connect the electric wires to the electric appliances. The wire holder has a plurality of wire passing holes which are respectively provided with annular rubber gaskets for preventing intrusion of water into the housing through the wire passing holes, and at the same time, for protecting surfaces of the electric wires. The wire holder of this type is described, for example, in JP-A-2002-25685.

### SUMMARY

The wire harness of this type is generally so constructed that a set of the wire harness includes two pieces of the electric wires. For this reason, in case where the electric wires to be connected to the electric appliances is increased in number, the set number of the wire harnesses and the number of the wire holders are increased accordingly, and the number of the housings to be formed on the case side is increased. Moreover, for the purpose of obtaining desired securing forces with respect to the respective housings, a plurality of locking structures are provided on side faces of the wire holder, for example, in a circumferential direction. Therefore, there is such a problem that on occasion of attaching the wire holders respectively to the housings, working spaces between the wire holders become narrow, and hence, working efficiency is deteriorated.

One or more embodiments of the invention has been made in view of the above described circumstances, and an object thereof is to provide a wire holder which can be assembled to an object to be attached with high efficiency.

According to an aspect of the invention, there is provided a wire holder attachable to a tubular body, the tubular body including a plurality of first engagement parts, the wire holder including: a holder body enclosing a plurality of electric wires and attachable to the tubular body; a plurality of wire passing holes which are formed in the holder body; and a plurality of second locking parts which are provided on a periphery of the holder body and which are engageable with the respective first locking parts, wherein the holder body is divided along an axial direction of the wire passing holes into a plurality of holder elements containing at least a first holder element and a second holder element adjacent to the first holder element, and is formed by superposing the plurality of holder elements, wherein each of the plurality of holder elements includes at least one of the plurality of wire passing holes and at least one of the plurality of second locking parts, wherein a first dividing surface of the first holder element is provided with a rib extending in the axial direction, and wherein a second dividing surface of the second holder element opposing the first dividing surface is provided with a groove with which the rib is engaged by sliding.

### BRIEF DESCRIPTION OF THE DRAWINGS

FIG. 1 is a perspective view showing a wire harness in a state assembled to a housing;

FIG. 2 is a perspective view of a wire holder to which the invention is applied, as seen from a front side;

FIG. 3 is a perspective view of the wire holder to which the invention is applied, as seen from a rear side;

FIG. 4 is a perspective view of the wire holder in FIG. 3, in a state separated into two holder elements; and

FIG. 5 is an explanatory view for explaining operation for assembling the two holder elements.

### DETAILED DESCRIPTION

Now, a wire holder in an embodiment according to the invention will be described referring to the drawings.

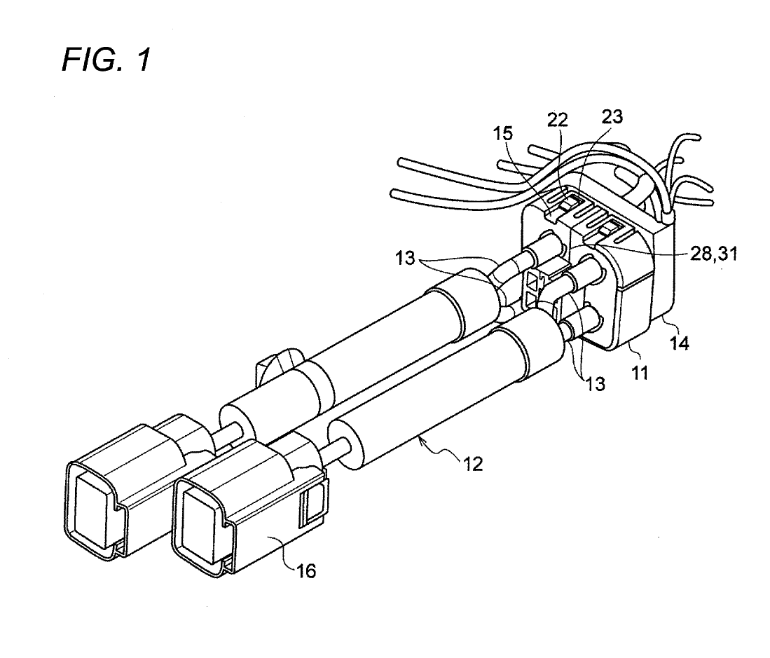

As shown in FIG. 1, a wire holder 11 (also called as a rear holder) in this embodiment is used for the purpose of connecting electric wires 13 of a wire harness 12 to electric appliances which are mounted on a vehicle such as an electric car, hybrid car, and so on. Specifically, a case wall 14 of a case which contains the electric appliances is provided with a housing 15 (a tubular body) which is projected in an angled cylindrical shape, and the wire holder 11 through which the electric wires 13 of the wire harness 12 are passed is attached to the housing 15. In this manner, distal ends of the electric wires 13 which are guided out from the wire holder 11 are introduced into the case through the housing 15 thereby to be connected to the electric appliances. It is to be noted that the case wall 14 in FIG. 1 represents a part of the case.

The wire harness 12 in this embodiment is formed by bundling two pieces of the electric wires 13 into one set. FIG. 1 shows a state where the electric wires 13 (four pieces) in the two sets of the wire harnesses are respectively introduced into the case by way of the wire holder 11. One ends of the respective electric wires 13 are connected to the electric appliances inside the case, while the other ends of the electric wires 13 are connected to connector housings 16 to be connected to mating connectors. More specifically, terminal metal fittings which are not shown are contained in the connector housings 16, and the other ends of the electric wires 13 are connected to these terminal metal fittings.

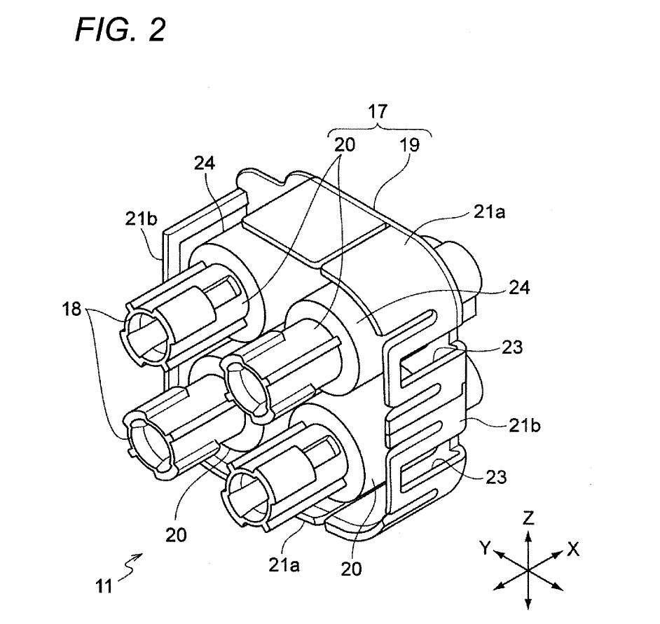

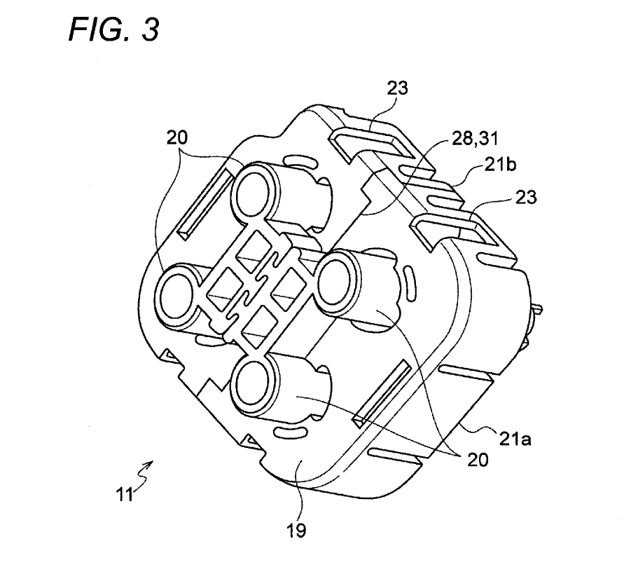

FIG. 2 shows an outer appearance of the wire holder 11, as seen from a front side, FIG. 3 shows the outer appearance of the wire holder 11, as seen from a back side in FIG. 2, that is, from a rear side. In FIG. 2, an X direction represents a longitudinal direction of the wire holder 11. Herein, the front side means a direction in which the wire holder 11 is attached to the housing 15 (the right side in FIG. 1), and the rear side means a direction in which the wire holder 11 is detached from the housing 15 (the left side in FIG. 1). A Y direction represents a lateral direction of the wire holder 11, and a Z direction represents a vertical direction of the wire holder 11. Herein, an upper side in the Z direction means an upper side of the wire holder 11, and a lower side in the Z direction means a lower side of the wire holder 11. In the following description, these directions are applied also in the other drawings.

The wire holder 11 is formed of synthetic resin by molding. The wire holder 11 includes a holder body 17 to be attached to the housing 15, and a plurality of wire passing holes 18 through which the electric wires 13 are passed. The holder body 17 has a bottom plate 19 in a rectangular shape, and four cylindrical parts 20 which are extended in the longitudinal direction passing through the bottom plate 19. The wire passing holes 18 are respectively formed inside the cylindrical parts 20. The cylindrical parts 20 are arranged in such a manner that their respective axes may be substantially parallel to each other. A wall part 21 which is erected from four edges of the bottom plate 19 to the front side is formed around the cylindrical parts 20 so as to surround these cylindrical parts 20.

The wall part 21 includes two pairs of wall portions 21a, 21b which oppose each other. Each of a pair of the wall portions 21a is formed in a shape of a rectangular side plate. Each of a pair of the wall portions 21b has two locking hooks 23 (second locking parts) to which locking projections 22 (first locking parts) of the housing 15 are adapted to be locked. The wall portions 21a, 21b may be continuously formed with each other in an angled cylindrical shape, or may be provided separately.

Each of the cylindrical parts 20 is provided with a large diameter part 24 projecting from the bottom plate 19 to the front side, and the cylindrical part 20 is so formed as to protrude from a front end face of the large diameter part 24. Although not shown in the drawings, a wall part in an angled cylindrical shape which forms an outer side face of the housing 15 is adapted to be inserted into a space which is formed between the large diameter part 24 and the wall part 21. An annular rubber gasket which is not shown is fitted to each of the cylindrical parts 20 along a circumferential direction of an inner peripheral face which forms the wire passing hole 18, so that a gap between an outer peripheral face of the electric wire 13 which is passed through the wire passing hole 18 and the inner peripheral face of the wire passing hole 18 can be water-tightly sealed. Moreover, another annular rubber gasket which is not shown is fitted to the outer peripheral face of each of the cylindrical parts 20, so that a gap between the outer peripheral face of the cylindrical part 20 and an inner peripheral face of a tube body in a cylindrical shape which is formed inside the housing 15, although not shown, when the wire holder 11 is attached to the housing 15, can be water-tightly sealed.

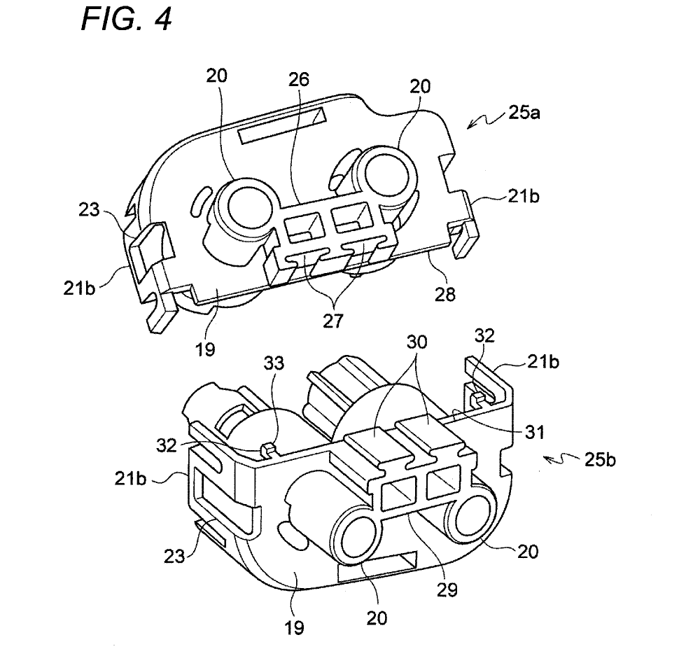

Then, main structure of this embodiment will be described. The wire holder 11 in this embodiment is formed by superposing two holder elements 25a, 25b which are divided in two along an axial direction of the wire passing holes 18. FIG. 4 shows the wire holder 11 in FIG. 3, in a state separated into the two upper and lower holder elements 25a, 25b. The wire holder 11 is divided into an upper half and a lower half at a substantially middle position in a direction of its height. The bottom plate 19 is divided at a position between the cylindrical parts 20 at the upper side and the lower side, and at the same time, divided between the two locking hooks 23 each at the upper side and the lower side of a pair of the wall portions 21 b. Therefore, the holder elements 25a, 25b which have been divided are respectively provided with the two cylindrical parts 20 and the two locking hooks 23.

The holder element 25a is provided with a first protruding part 26 in an angled cylindrical shape which is projected rearward from the bottom plate 19. The first protruding part 26 is formed continuously from the cylindrical parts 20. Two grooves 27 extending in an axial direction of the holder element 25a are formed in a lower end part of the first protruding part 26. Lower end faces of the grooves 27 form a part of a dividing surface 28 of the bottom plate 19.

On the other hand, the holder element 25b is provided with a second protruding part 29 in an angled cylindrical shape which is projected rearward from the bottom plate 19. The second protruding part 29 is formed continuously from the cylindrical parts 20. Two ribs 30 extending in an axial direction of the holder element 25b are formed in an upper end part of the second protruding part 29 in a projecting manner. The upper end part of the second protruding part 29 forms a part of a dividing surface 31 of the bottom plate 19. Therefore, the ribs 30 are projected upward than the dividing surface 31. The ribs 30 are so formed as to be engaged with the grooves 27, and can slide along the grooves 27.

The holder element 25b is provided with two lock parts 32 extending in a cantilever shape from both ends of the bottom plate 19 to the front side. Each of the lock parts 32 is so formed as to be elastically deformed in a vertical direction at its front end side. A locking projection 33 is formed so as to project upward from the front end of the lock part 32. The locking projection 33 has a taper face in such a shape that its width in the longitudinal direction gradually grows narrow as going upward, and is so provided as to project upward than the dividing surface 31 of the bottom plate 19. On the other hand, the holder element 25a is provided with engaging parts to be engaged with the locking projections 33 of the lock parts 32, although not shown in the drawings. In this manner, when the holder element 25a is relatively moved to a prescribed position of the holder element 25b, in a state where the ribs 30 are engaged with the grooves 27, the locking projections 33 of the lock parts 32 are engaged with the engaging parts, thereby to prevent at least the holder element 25a from moving to the front side with respect to the holder element 25b.

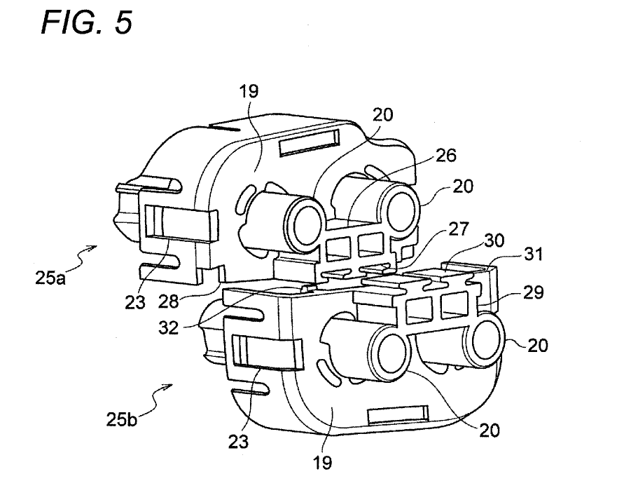

In order to assemble the holder elements 25a, 25b which are thus constructed to each other, as shown in FIG. 5, their dividing surfaces 28, 31 are arranged so as to oppose each other, as a first step, and at the same time, the holder element 25a is positioned at the front side of the holder element 25b. Then, the ribs 30 of the holder element 25b are engaged with the grooves 27 of the holder element 25a, and the holder element 25a is moved rearward relative to the holder element 25b. Accordingly, the ribs 30 which have been fitted into the grooves 27 are slid along the grooves 27. Specifically, the holder element 25a slides to move in a state superposed on the holder element 25b, and in a state supported by the holder element 25b.

Meanwhile, by engaging the holder elements 25a, 25b with each other in this manner, the dividing surface 28 of the holder element 25a comes into contact with the lock parts 32 of the holder element 25b, that is, the locking projections 33 thereby to press the lock parts 32 downward. Accordingly, the lock parts 32 are elastically deformed downwardly. When the holder element 25a which moves, while pressing the lock parts 32, has moved to the prescribed position of the holder element 25b, the lock parts 32 are elastically restored, and the locking projections 33 are engaged with the engaging parts of the holder element 25a to be locked. As the results, relative movements of the holder elements 25a, 25b are restrained both in a sliding direction and a direction perpendicular to the sliding direction, and the holder elements 25a, 25b are brought into an integrated state as the wire holder 11.

Thereafter, the electric wires 13 of the wire harness 12 are respectively passed through the cylindrical parts 20 of the wire holder 11 which has been thus integrated. Then, the wall part 21 of the wire holder 11 having the electric wires 13 inserted is fitted to the housing 15 in a manner of covering the housing 15. As the results, the locking projections 22 of the housing 15 are respectively locked to the locking hooks 23 of the wire holder 11, and the wire holder 11 is fixed to the housing 15. On this occasion, the cylindrical parts 20 of the wire holder 11 are respectively inserted into the tube bodies of the housing 15. Then, the electric wires 13 which are guided out from the respective cylindrical parts 20 are introduced into the case through the tube bodies, and electrically connected to the electric appliances.

According to this embodiment, the two holder elements 25a, 25b through which the electric wires 13 are passed can be attached to the single housing 15, after they have been integrated. Therefore, it is possible to reduce the number of the housings 15 with respect to the set number of the wire harnesses 12 (the number of the electric wires 13). Moreover, by engaging the grooves 27 with the ribs 30, the relative movements of the holder elements 25a, 25b can be restrained both in the sliding direction and the direction perpendicular to the sliding direction. Therefore, the holder elements 25a, 25b need not be provided with members for fixing them to the housing 15 (for example, the locking hooks 23) on their opposing faces (for example, the dividing surfaces 28, 31), and consequently, it is possible to achieve reduction of size of the wire holder 11. Accordingly, it is possible to secure a wide space for attaching the wire holder 11 to the housing 15, and hence, it is possible to enhance working efficiency on occasion of attaching the wire holder 11 to the housing 15. It is to be noted that the locking hooks 23 can be provided on the wall portions 21a instead of the wall portions 21b.

Moreover, because the wire holder 11 is provided with the lock parts 32, it is possible to restrain the relative movements of the holder elements 25a, 25b in the sliding direction. Accordingly, the wire holder 11 can be fixed to the housing 15 only by providing the locking hooks 23 on the wall portions 21 b, without providing the locking hooks 23 on the wall portions 21a, as in this embodiment, in the respective holder elements 25. Therefore, it is possible to make the wire holder 11 more compact, and it is possible to attach the wire holder 11 to the housing 15 more efficiently.

Further, in this embodiment, the electric wires 13 (two pieces) in the one set of the wire harness 12 can be passed through one piece of the holder element 25 for electrical continuity. Therefore, it is possible to easily check the electrical continuity of the wire harness 12, thereby to enhance productivity.

Although the embodiment of the invention has been specifically described above referring to the drawings, the embodiment is only an example of the invention, but the invention is not limited only to the structure in the above described embodiment. It is apparent that the invention includes any change in design within a scope not deviating from the gist of the invention.

For example, in this embodiment, the housing 15 protruding from the case wall 14 of the case which contains the electric appliances has been described as an example of the object to which the wire holder 11 is to be attached. However, the invention is not limited to this, but can be applied, for example, to a case where the two wire harnesses 12 are connected to each other. Specifically, the wire holder 11 in this embodiment can be attached for use, for example, to the connector housing 16 of the wire harness 12 to be mated, and so on.

Moreover, in this embodiment, an example of integrally forming the single wire holder 11 by coupling the two holder elements 25a, 25b has been described. However, the invention is not limited to this, but it is also possible to form the single wire holder 11, by coupling more than three holder elements 25 together. In this case, it is necessary that the adjacent holder elements 25 are so formed as to be integrated by engaging the grooves 27 and the ribs 30 with each other. It is also necessary that the holder elements 25 are respectively provided with the cylindrical parts 20 and the locking hooks 23.

Moreover, in this embodiment, an example where the locking projections 33 of the lock parts 32 are engaged with the engaging parts of the holder element 25a has been described. However, the engaging parts may be formed as engaging holes or engaging grooves with which the locking projections 33 can be engaged. Alternatively, the locking projections 33 may be engaged by simply hooking them on the bottom plate 19. Specifically, when the wire holder 11 is attached to the housing 15, the holder elements 25a, 25b are restrained from relatively moving rearward, and therefore, it would be sufficient that the engaging parts restrain the holder elements from moving at least in a direction of separating from the housing 15, that is, from relatively moving to the front side.

One or more embodiments of the invention provides a wire holder attachable to a tubular body including a plurality of first engagement parts, the wire holder including: a holder body enclosing a plurality of electric wires and attachable to the tubular body; a plurality of wire passing holes which are formed in the holder body; and a plurality of second locking parts which are provided on a periphery of the holder body and which are engageable with the respective first locking parts, wherein the holder body is divided along an axial direction of the wire passing holes into a plurality of holder elements containing at least a first holder element and a second holder element adjacent to the first holder element, and is formed by superposing the plurality of holder elements, wherein each of the plurality of holder elements includes at least one of the plurality of wire passing holes and at least one of the plurality of second locking parts, wherein a first dividing surface of the first holder element is provided with a rib extending in the axial direction, and wherein a second dividing surface of the second holder element opposing the first dividing surface is provided with a groove with which the rib is engaged by sliding.

According to the above described structure, the wire holder can be attached to the tubular body, in a state where a plurality of the holder elements are engaged with each other to be integrated, and therefore, it is possible to reduce the number of the tubular bodies with respect to the number of the electric wires. Moreover, by engaging the holder elements with each other, relative movements of the holder elements can be restrained, and hence, there is no necessity of providing the second locking parts on their opposing faces. By integrating the wire holder, reduction of size of the wire holder can be achieved. As the results, it is possible to secure a space for attaching the wire holder to the tubular body, and hence, it is possible to assemble the wire holder to the tubular body with high efficiency.

The wire holder may be configured such that at least one of the first holder element and the second holder element includes a lock part which prevents the other of the first holder element and the second holder element from sliding in a direction separating from the tubular body. According to this structure, in a state where the integrated wire holder is attached to the tubular body, the relative movements of the holder elements can be reliably restrained. As the results, it is possible to make the wire holder more compact, and it is possible to assemble the wire holder to the tubular body with high efficiency.

According to one or more embodiments of the invention, it is possible to assemble the wire holder to the object to be attached with high efficiency.

What is claimed is:

1. A wire holder attachable to a tubular body, the tubular body comprising a plurality of first engagement parts, said wire holder comprising:
a holder body enclosing a plurality of electric wires and attachable to the tubular body;
a plurality of wire passing holes which are formed in the holder body; and
a plurality of second locking parts which are provided on a periphery of the holder body and which are engageable with the respective first locking parts,
wherein the holder body is divided along an axial direction of the wire passing holes into a plurality of holder elements containing at least a first holder element and a second holder element adjacent to the first holder element, and is formed by superposing the plurality of holder elements,
wherein each of the plurality of holder elements comprises at least one of the plurality of wire passing holes and at least one of the plurality of second locking parts,
wherein a first dividing surface of the first holder element is provided with a rib extending in the axial direction, and
wherein a second dividing surface of the second holder element opposing the first dividing surface is provided with a groove with which the rib is engaged by sliding.

2. The wire holder according to claim 1,
wherein at least one of the first holder element and the second holder element comprises a lock part which prevents the other of the first holder element and the second holder element from sliding in a direction separating from the tubular body.
